(19) United States
(12) Patent Application Publication
(10) Pub. No.: US 2006/0293825 A1
(43) Pub. Date: Dec. 28, 2006

(54) Method and device for assisting a speed-control function on a motor vehicle

(76) Inventors: Peter Sporl, Ravensburg (DE); Oliver Iden, Weissensberg (DE)

Correspondence Address: DAVIS & BUJOLD, P.L.L.C., 112 PLEASANT STREET, CONCORD, NH, 03301, US

(21) Appl. No.: 11/137,718

(22) Filed: May 25, 2005

(30) Foreign Application Priority Data
May 26, 2004 (DE) 10 2004 025 741.8

(51) Int. Cl. B60T 8/32; G06F 17/00

(52) U.S. Cl. 701/93; 701/70

(57) ABSTRACT

The invention relates to a method and device for operating a motor vehicle with a speed and/or distance control device (141) the same as with an automatic transmission (131) in which, departing from an actual driving speed (C), a preset nominal driving speed (D) is autonomously regulated and in which the adaptation of the actual driving speed (C) to the nominal driving speed (D) is controlled by a ratio change of the automatic transmission (131). The ratio change control is effected on the basis of a virtual accelerator pedal value (J, J′, J″) derived from the real deviation of the accelerator pedal 915) by the driver, the definition of the virtual accelerator pedal value (J, J′, J″) being controlled by the divergence of the driving speed (C) from the nominal driving speed (D), by the vehicle longitudinal acceleration (E) and/or by the torque (B) of the vehicle prime mover.

The invention concerns a method for operating a motor vehicle with a speed and/or distance control device, the same as with an automatic transmission, in which starting from an actual driving speed, a preset nominal driving speed is autonomously controlled, in which the adaptation of the actual driving speed to the nominal driving speed is controlled by a ratio change of the automatic transmission and in which the ratio change control is carried out based on a virtual accelerator pedal value derived from the real deviation of the accelerator pedal by the driver. The invention further concerns according to claim 16 a device for applying such a method and according to claim 26 a vehicle equipped so that on this method and device can be purposefully operated.

It is known that a motor vehicle can be equipped with a so-called speed control unit which enables the driver to constantly keep a driving speed established by him without the wheel torque having to be manually controlled at the same time. With such a speed control unit, it is also possible to automatically reach and control a previously stored speed again.

Inasmuch as in a motor vehicle thus equipped an automatic transmission is also built up; it is possible by adequate automatic selection of the transmission ratio to assist the functions of the speed control unit so as to make available to the driver greater power reserves and better driving characteristics, depending on the environmental conditions of the vehicle, especially on the gradient of the road.

With this background, it is known from DE 38 75 206 T4 that an optimal cooperation of the control functions for adjustment of the reduction ratio of an automatic transmission and of the speed control function of speed control device can consist, for example, in maintaining a driving speed preset by the driver speed controller first compares the adjusted speed with the actual driving speed and, according to the speed difference found, actuates a power adjusting element, such as a throttle valve on an internal combustion engine of the vehicle, which serves as a prime mover.

Inasmuch as the road often has gradient changes on account of the comparatively slow reacting prime mover to the quick performance change settings, fluctuations result in the driving speed which can be reduced, for example, by changing the transmission reduction ratio. To that end, DE 38 75 206 T4 proposes a driving control system for a motor vehicle having a continuously adjustable force transmission in which a throttle valve of a motor can be adjusted, via an adjusting element, so that the driving speed and the adjusted speed converge and which has ways for lowering the reduction ratio. In this drive control system, it further contains a switch to be manually actuated for producing an acceleration signal which causes the adjusting element to open the throttle valve, such that said ways correspond to the acceleration signal produced and that the reduction ratio is reduced by a predetermined amount.

It is disadvantageous in this speed control and ratio changing system that in it is used a manually produced acceleration signal directly for ratio control and besides the taking into account of other driving state parameters is not implemented.

From DE 101 15 052 A1 are also known a method and device for adjusting a transmission ratio in a motor vehicle with distance and/or driving speed control. From said publication is to be deduced that in a conventional motor vehicle having an otto-motor, the throttle valve is mechanically controlled directly by accelerator pedal deviation. Hereby result in a non-linear accelerator pedal torque characteristic familiar to skilled drivers.

In vehicles having mechanical decoupling of accelerator pedal and performance adjusting element of the internal combustion engine, however, the driver no longer mechanically assumes the throttle valve position by an accelerator pedal deviation, but signalizes thereby his desired performance or the motor output torque desired. To be able to convert this desired performance to a signal for adjusting the performance adjustment element of the internal combustion engine, the actual accelerator pedal position is coordinated with a motor performance with the aid of a characteristic field to the valve of which the performance adjusting element is adjusted.

The transmission ratio of an automatic transmission is also known and is usually adjusted depending essentially on the motor load (throttle valve position) and on the driving speed.

To maintain the non-linear accelerator pedal motor torque characteristic to which the driver is used, in a combination of motor control system in which the accelerator pedal and the performance adjusting element of the internal combustion engine are mechanically uncoupled with conventional transmission control, the transmission gearshifts are carried out based on a so-called “virtual accelerator pedal valve”. This virtual accelerator pedal valve now no longer corresponds here to the driver's torque or performance desire, but to the real accelerator pedal valve (that is, accelerator pedal angle) at which the required vehicle propulsion adjusted.

By this procedure, in a reciprocal action with the control function of the driving speed controller, a problem appears when the nominal torque preset by the latter of the internal combustion engine is close to the maximum torque of this prime mover. In this area, a small change of the nominal torque leads already to a great step in the virtual accelerator pedal valve whereupon a change of the reduction ratio is spontaneously triggered by the transmission control. Especially in case of only a small difference between said nominal torque and the maximum motor torque, this transmission shift disturbs the vehicle driver.

According to the method introduced in DE 101 15 052 A1, those disturbing shifts during the speed control operation are prevented or delayed. It is provided for the purpose that in the normal operation of the vehicle, that is, without speed control function, the performance adjusting element of the internal combustion engine is controlled according to the accelerator pedal position and to a non-linear characteristic field of the bevel engine torque. The ratio of the automatic transmission is here controlled in a conventional manner.

During the speed control operation there is produced by the adjustment of the speed control unit a preset nominal value by means of a characteristic field inverse to the first mentioned characteristic filed (that is, a motor torque-bevel characteristic field) and inverse or virtual accelerator pedal value which, in accordance with the actual torque of the prime mover, is used directly or after a value limitation to the ratio control of the automatic transmission. This method and the appertaining device are criticized as imperfect.

Against this background, the invention is based on the problem of introducing a method and device for operating a vehicle speed controller and for adjusting the ratio of an automatic transmission in a motor vehicle with which a pendular shift is prevented better than formerly and spontaneous acceleration operations are possible by changing the transmission reduction ratio. In addition, a vehicle is introduced which is equipped so that therewith the method and the device can be used.

The solution of the problem results for the device from the features of the main claim and for the method from the independent claim 16. According to claim 26 the invention concerns also a vehicle with which an inventive method can be applied to said device. Advantageous embodiments and developments of the invention can be understood from the dependent claims.

For a better understanding of the invention features mentioned herebelow, it is indicated, relative to the method, that by blocks, function blocks, processing blocks, calculation blocks, modules, comparators, etc., program steps, program modules or sub-programs is meant by at least one superposed control and regulation program. The at least one control and regulation program is worked off in a separate computer, a transmission control unit, a speed control unit and/or in a distance control unit. To that extent, said blocks, function blocks, processing blocks, calculation blocks, modules, comparators or others can also be implemented as device component parts, such as fixed coordinated computer structures.

The invention accordingly relates to a method for operating a motor vehicle with a speed and/or distance control device, the same as with an automatic transmission in which, departing from an actual driving speed, a preset nominal driving speed is autonomously controlled, in which the adaptation of the actual driving speed to the nominal driving speed is controlled by a ratio change of the automatic transmission and in which the ratio change control is carried out based on a virtual accelerator pedal valve derived from the actual deviation of the accelerator pedal by the driver, the specification of the virtual accelerator pedal value being controlled by the deviation of the actual vehicle speed relative to the nominal driving speed, by the vehicle longitudinal acceleration or vehicle longitudinal retardation and/or by the torque of the prime mover of the vehicle.

In this method, the virtual accelerator pedal valve is preferably changed in small incremental steps. This is of special advantage particularly during a ratio change operation in a continuously variable reduction-ratio changing automatic transmission, such as a CVT.

According to another advantageous design of the inventive method, it is provided that for ensuring as dynamic as possible a start of the ratio change, the virtual accelerator pedal value is changed for introducing a ratio change by an offset value of a magnitude greater than that of an incremental change of the same.

Moreover, it is deemed advantageous for controlling the start of the ratio change if for determining the virtual accelerator pedal value reaching and/or falling below at least one preset motor torque threshold value is taken into account.

In this connection, for determining the virtual accelerator pedal value, it can also be logical if reaching or exceeding at least one preset threshold value of a relative motor torque is taken into account, the relative motor torque being defined as the ratio of the actual motor torque to the maximum possible motor torque at the determined rotation speed of the motor.

In addition, it is deemed convenient for determining the virtual accelerator pedal value if, therefore is taken into account, the reaching and/or exceeding of at least one preset threshold value for the driving speed and/or the reaching an/or exceeding of at least one preset threshold value of the longitudinal acceleration of the vehicle.

Insofar as during a constant speed control operation, when the tractional resistance of the vehicle increases, a preset nominal driving speed is again to be reached then, according to a preferred embodiment of the inventive method, the motor torque is first increased and then, when the motor torque emitted by the prime mover is not enough to keep or reach the nominal driving speed again, starting from a predetermined driving speed deviation to nominal driving speed, the virtual accelerator pedal value is gradually increases. This gradual increase of the virtual accelerator pedal value to the ratio change control is terminated when the motor power suffices to reach at least a predetermined longitudinal acceleration of the vehicle.

Furthermore, in a driving sped resumption control for again reaching a preset nominal driving speed, starting from an actually lower driving speed to the decision of whether the virtual accelerator pedal value should be increased, it can be of advantage to evaluate between the actual driving speed and the nominal driving speed, together with the speed difference, the exceeding of motor torque threshold or of a threshold value of the relative motor torque. It is, in addition, advantageous to also check that the vehicle longitudinal acceleration threshold value F has not been exceeded.

It also can be provided that when the motor torque suffices to raise the vehicle speed to the nominal driving speed with a vehicle longitudinal acceleration above the threshold value F, a change of ratio of the transmission is eliminated.

It can finally be provided that the virtual accelerator pedal value for carrying out a transmission upshift be gradually reduced when the motor torque falls below a preset torque threshold value and the virtual accelerator pedal value is higher than a predetermined minimum value for the virtual accelerator pedal value.

A concrete method for carrying out a constant speed driving mode based on a preset nominal driving speed can be operated regarding the speed and/or distance control device, the same as an automatic transmission, as follows. Determining a reduction of the driving speed from the preset nominal driving speed by a preset driving speed differential amount. Increase the motor torque by control of the performance adjusting element of the vehicle prime mover. Insofar as during a preset motor rotational speed, the prime mover emits its maximum torque, the driving speed drops below a preset threshold value N and the vehicle longitudinal acceleration has, compared to the initial situation, an insufficient acceleration value, release a timer. After expiration of a preset time interval t₃-t₄, when the prime mover still emits its maximum torque at the current rotational speed and the driving speed is below the driving speed threshold value N, the same as the vehicle longitudinal acceleration is below a longitudinal acceleration threshold value F, add the offset value to the actual virtual accelerator pedal value and thereby begin a transmission downshift. Incremental increase of the virtual accelerator pedal value and therewith going on transmission downshift until the vehicle longitudinal acceleration has reached a preset positive acceleration threshold value G. Terminate the incremental increase of the virtual accelerator pedal value and thus end the downshift. Reduce the motor torque when the driving speed has reached the nominal driving speed.

Another method or resuming a preset nominal driving speed can be operated with regard to speed and/or distance control device and to the automatic transmission as follows. At a driving speed below a preset threshold N, raise the motor torque to a torque threshold value. When upon reaching said torque threshold value the driving speed is still below the speed threshold value N and the vehicle longitudinal acceleration has a value below the threshold value F, release a timer. After expiration of a preset time interval t₉-t₁₀, when the the prime mover emits its maximum torque at the current rotational speed and the driving speed is below the speed threshold value n, the same as the vehicle longitudinal acceleration has a value below the threshold value F, add an offset value to the virtual accelerator pedal value and therewith being a transmission downshift. Incremental enlargement of the virtual accelerator pedal value and therewith going on added transmission downshift until the vehicle longitudinal acceleration has reached a preset positive threshold value G. Terminate the incremental increase of the virtual accelerator pedal value and therewith end the downshift. Reduce the motor torque when the driving speed has reached the nominal driving speed.

One other method for resuming a preset nominal driving speed can be operated with regard to speed and/or distance control device, the same as to the automatic transmission, as follows. At a driving speed below a preset speed threshold value N, increase the motor torque up to a torque threshold value. Upon reaching said torque threshold value, when the driving speed is still below the speed threshold value N and the vehicle longitudinal acceleration has a value below the threshold value F, release the timer. After expiration of a preset time interval t₉-t₁₀, when the prime mover emits its maximum torque at the current rotational speed and the driving speed is below the speed threshold value N, the same as the vehicle longitudinal acceleration has a value below the threshold value F, add an offset value to the virtual accelerator pedal value and begin a transmission downshift. Incremental increase of the virtual accelerator pedal value and therewith going on downshift until the accelerator pedal value has reached a predetermined maximum accelerator pedal value. Terminate the downshift when the vehicle longitudinal acceleration has not exceeded a value G but the driving speed has reached a driving speed value O close to the nominal driving speed or has reached the nominal driving speed proper. Reduce the motor torque.

A method for resuming a preset nominal driving speed or for covering a route at constant driving speed can be operated with regard to a speed and/or distance control device, the same as to the automatic transmission, as follows. Inasmuch as the prime mover emits its maximum torque at the precise existing motor rotation speed, the driving speed is above an upper speed threshold value O and the virtual accelerator pedal value is between a maximum and a minimum value, reduce the motor torque. Insofar as the motor torque has reached a lower threshold value and the above mentioned conditions still hold, start a timer. When a predetermined time period has expired and the above mentioned conditions still hold, being a transmission upshift by incremental reduction of the virtual accelerator pedal value. Regulate the motor torque starting from a moment t₁₇ to constant maintenance of the vehicle speed. Terminate the upshift operation by ending the reduction of the virtual accelerator pedal value when this has reached a predetermined minimum value or terminate the upshift operation by ending the reduction of the virtual accelerator pedal value when the motor torque has reached a predetermined upper threshold value of the torque which is between the lower torque threshold value and the maximum motor torque that can be emitted at the current rotational speed.

As has been stated, the invention also relates to a device in a motor vehicle for applying at least one of the above methods with one speed and/or distance control device, one prime mover, one motor control unit, one automatic transmission, one transmission control unit and one computer where the computer is associated, according to signal technique, with the motor control unit, the transmission control unit and the speed/distance control device or is identical with one of said units. The device is further characterized by the computer having the following component parts: one input module for receiving information relative to the actual control status of the speed and/or distance control device; one initialization module for determining a virtual accelerator pedal value from the actual accelerator pedal actuation; one determination module to determine the motor torque, the vehicle acceleration and the difference between the actual driving speed and a preset nominal driving speed; one determination module to determine the actual status of the assistance of the speed control function by changing the transmission reduction ratio; one calculation module to calculate the actual virtual accelerator pedal value and one output module to issue the actual accelerator pedal value to the transmission control unit for control of the reduction ratio.

Regarding the initialization module it is preferably provided that it has one inquiry module where is determined whether the speed control device and/or the distance control device is active for the first time since the last starting operation of the vehicle or the last driving speed control assistant; the allocation module which in case of negative result of the inquiry in the inquiry module allocates the actual virtual accelerator pedal value for subsequent processing, and one processing block to be used in case of positive result of the inquiry and in which are determined the actual starting values for the virtual accelerator pedal value and the status value of assistance of the speed control or distance control device with regard to the transmission ratio operations.

Preferably the processing block has one calculation block in which the actual real accelerator pedal value can be checked in a maximum value generator as to whether said real accelerator pedal value is higher than a minimum value for the virtual accelerator pedal value; there being issued as output parameter of this maximum value generator, the existing value higher than the actual virtual accelerator pedal value.

It is also provided in this connection that the processing block comprises one other calculation block the input parameter of which is the precisely determined virtual accelerator pedal value that, in this other calculation block, it can be inquired in comparison step whether the actual virtual accelerator pedal value is higher than the minimum value for the virtual accelerator pedal value and that the output of said comparison step is connected with the other processing block with regard to a positive reply and with an additional processing block with regard to a negative reply, it being possible with the other processing block to set at two the status value in a status value memory and with the additional processing block to set at zero the status value in the status value memory.

The calculation module for calculating the actual virtual accelerator pedal value preferably has one first increment generator for an increase of the virtual accelerator pedal value, one second increment generator for a reduction of the virtual accelerator pedal value and one zero value increment generator.

It is further provided that the calculation module for calculating the actual virtual accelerator pedal value has one status memory for storing status code numbers (zero, one, two, three) which, in this sequence, indicate whether no activity is to take place regarding a change of the virtual accelerator pedal value, whether an increase of the virtual accelerator pedal value takes place at the time, whether at the time an existing virtual accelerator pedal value is to be kept or whether at the time an existing virtual accelerator pedal value is to be reduced.

This calculation module, in addition, has one program switch which is connected via additional elements with said increment generators. To update the existing virtual accelerator pedal value, it is further provided that via a feedback the virtual accelerator pedal value of the last calculation loop can be supplied to the addition elements.

In another development of the device for applying the introduced method, it is provided that with the program switch it is possible to relay the incrementally changed virtual accelerator pedal value for further processing, which was changed according to the assistance status just valid and stored in the status memory.

In addition, the calculation module for calculating the actual virtual accelerator pedal value has a minimum value memory for a determinable lower limiting value and a maximum value memory for a determinable upper limiting value of the virtual accelerator pedal value, the outlet of the program switch being connected with the inlet of a first comparator also connected with the minimum value memory. Besides, the outlet of the first comparator is connected with the inlet of a second comparator which is also connected with the maximum value memory. Therefore, at the outlet of the second comparator outcrops the virtual accelerator pedal value which corresponds to the established minimum value or to the established maximum value or is between the two values.

Finally, the invention also concerns a motor vehicle. The transmission is designed as an automatic transmission continuously changing the reduction ratio, for example, as CVT with beveled pulley.

To make clear the invention, enclosed with the description is a drawing with the aid of which one embodiment of the invention with other features and advantages is explained in detail herebelow. The drawing shows:

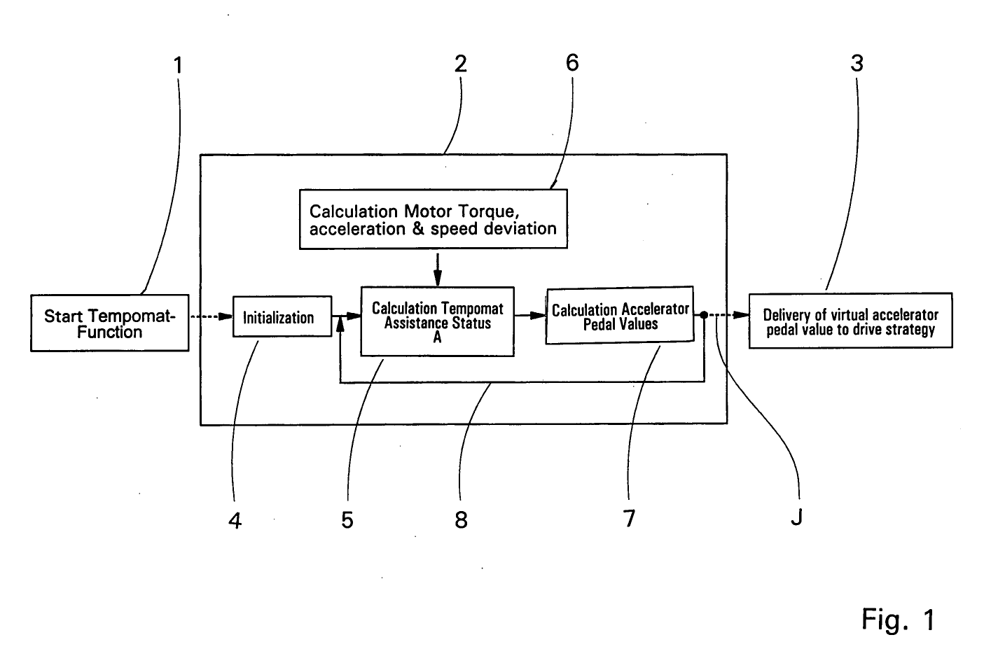

FIG. 1 shows a schematized graph of the program structure or of the function construction of a computer for assisting the operation of a speed control device and/or a distance control device by purposeful change of ratio of an automatic transmission;

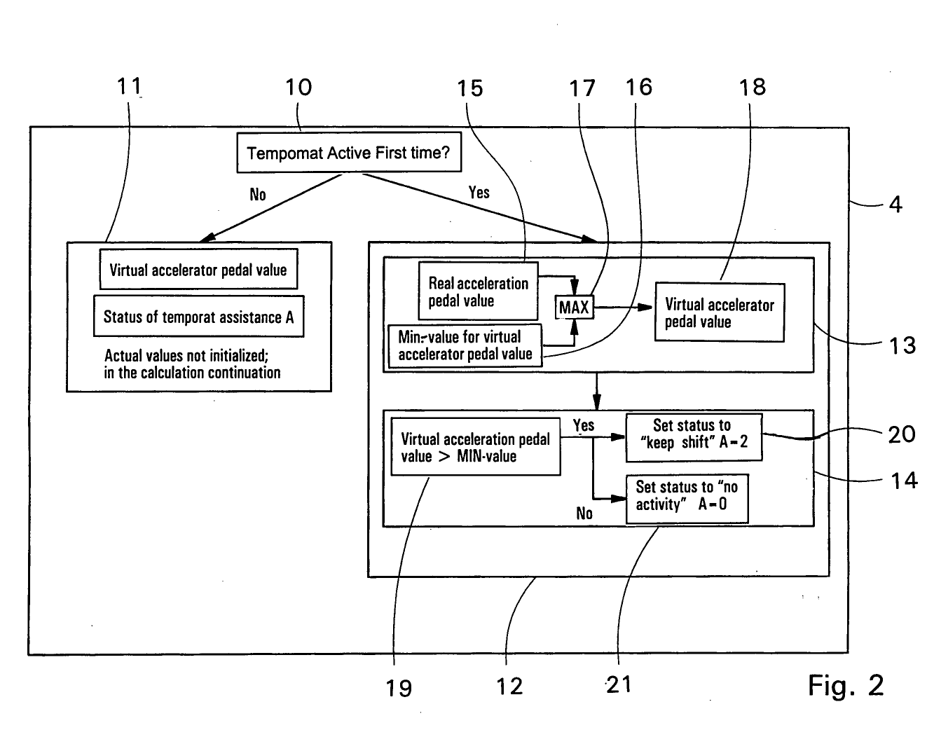

FIG. 2 shows a schematized graph of the operation cycle for initializing the program or of the computer, according to FIG. 1;

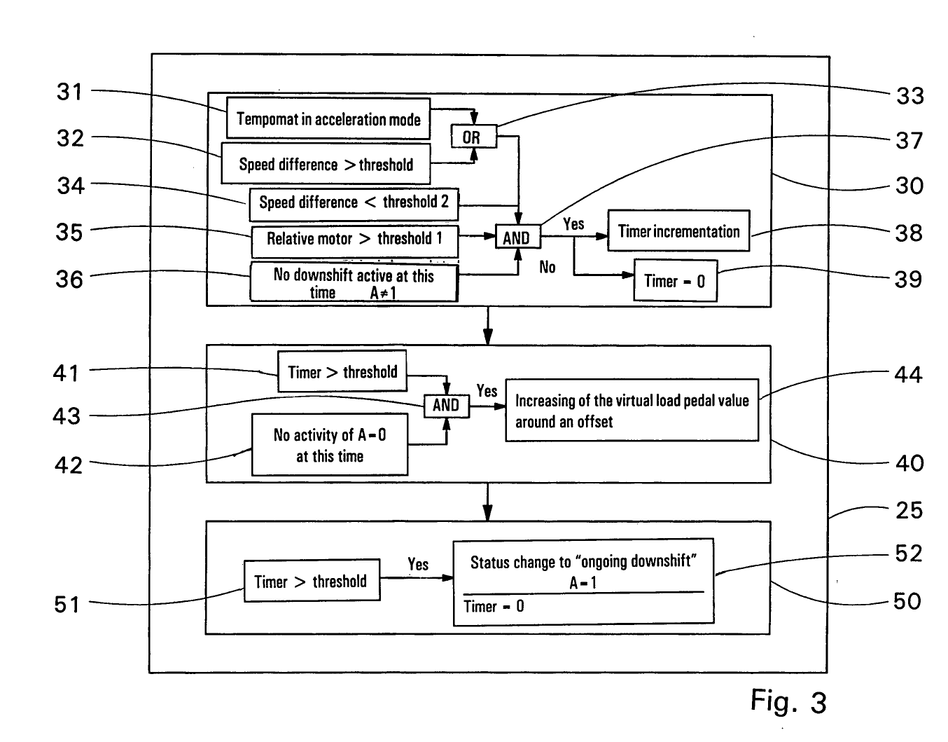

FIG. 3 shows a graph as in FIG. 2 but, regarding the determination of the assistance status when in a driving speed constant driving mode or a driving speed resumption mode, a downshift is carried out oriented to an increase of the virtual accelerator pedal value;

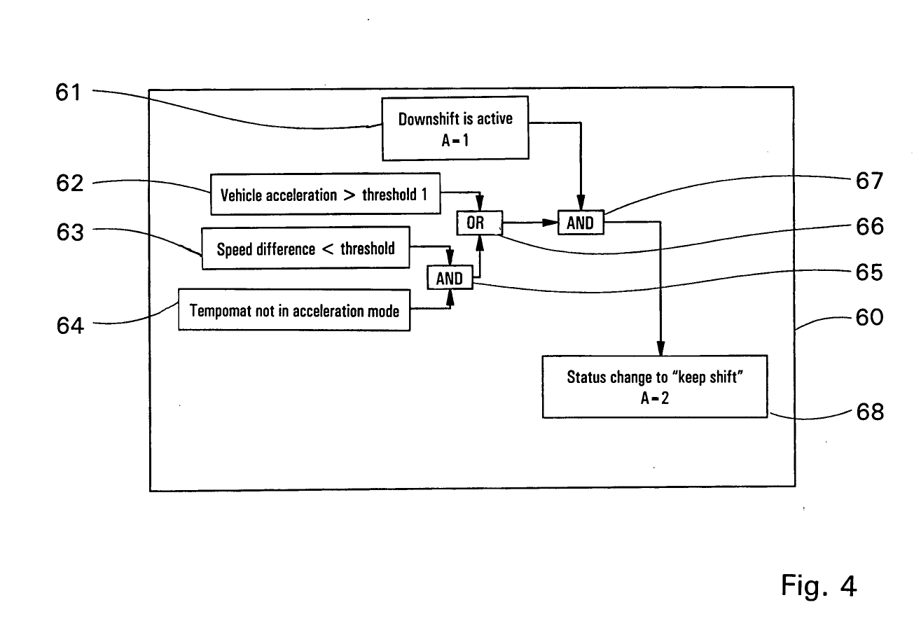

FIG. 4 is a graph as in FIG. 2 but, regarding the determination of the assistance status when during a speed constant driving mode or a driving mode or a driving speed resumption mode, a downshift is to be terminated in the sense of keeping an actual virtual accelerator pedal value;

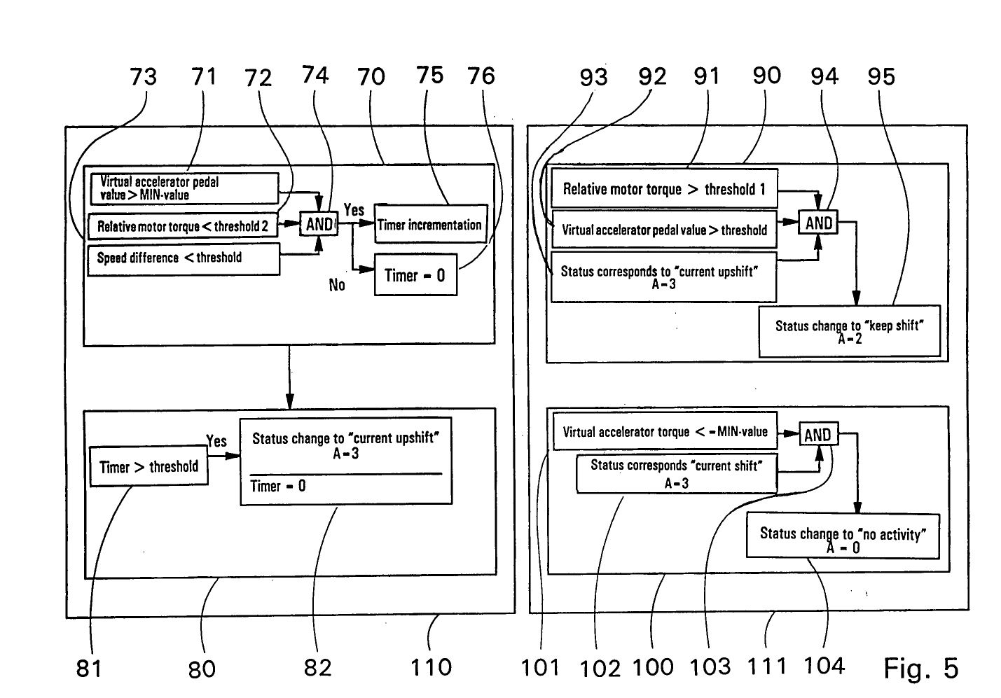

FIG. 5 is a graph as in FIG. 2 but, regarding the determination of the assistance status when during a driving speed constant mode or a driving speed resumption mode, an upshift is to be carried out or terminated by breaking down or keeping the virtual accelerator pedal value;

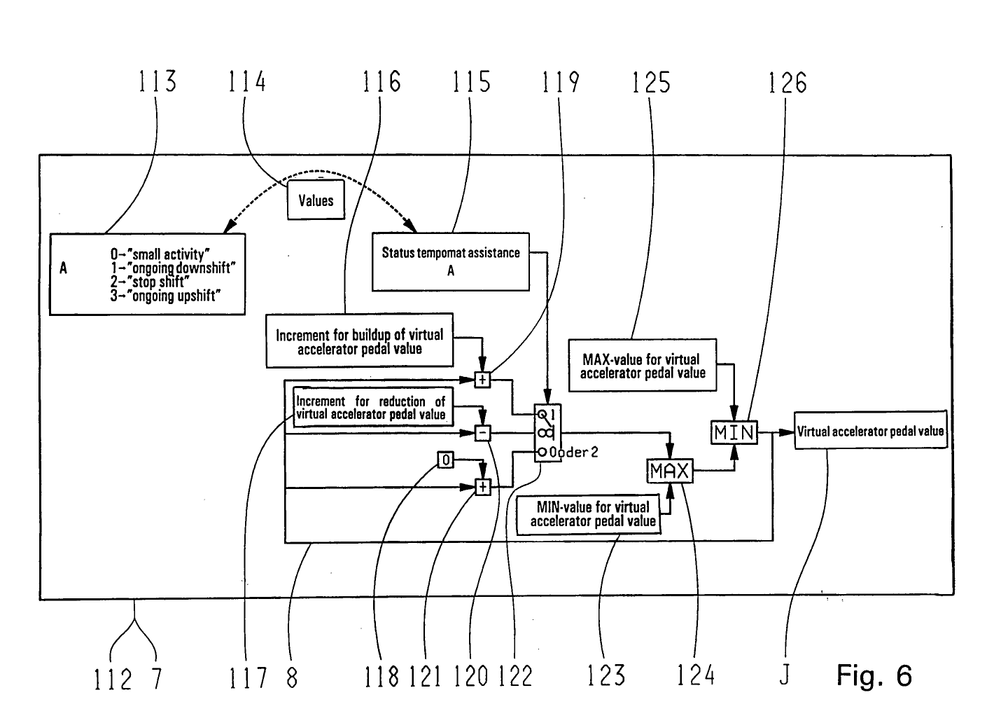

FIG. 6 is a graph as in FIG. 2 but, regarding the determination of the virtual accelerator pedal value, depending on said assistance status;

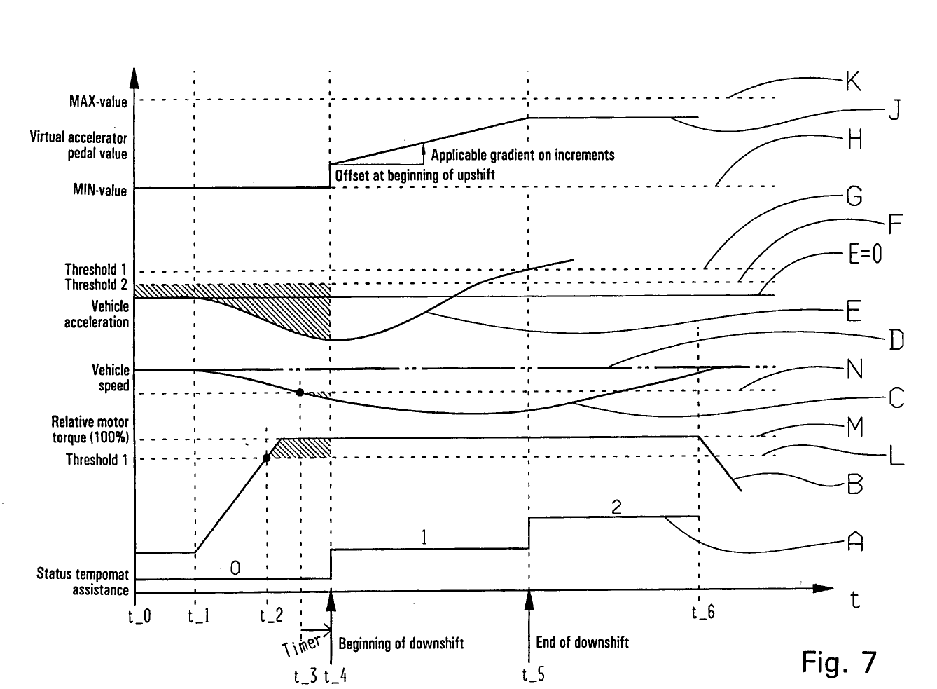

FIG. 7 is a diagram with vehicle characteristic value relevant to driving and ratio change plotted in the course of time, a transmission downshift in constant driving mode being effected by increasing the virtual accelerator pedal value;

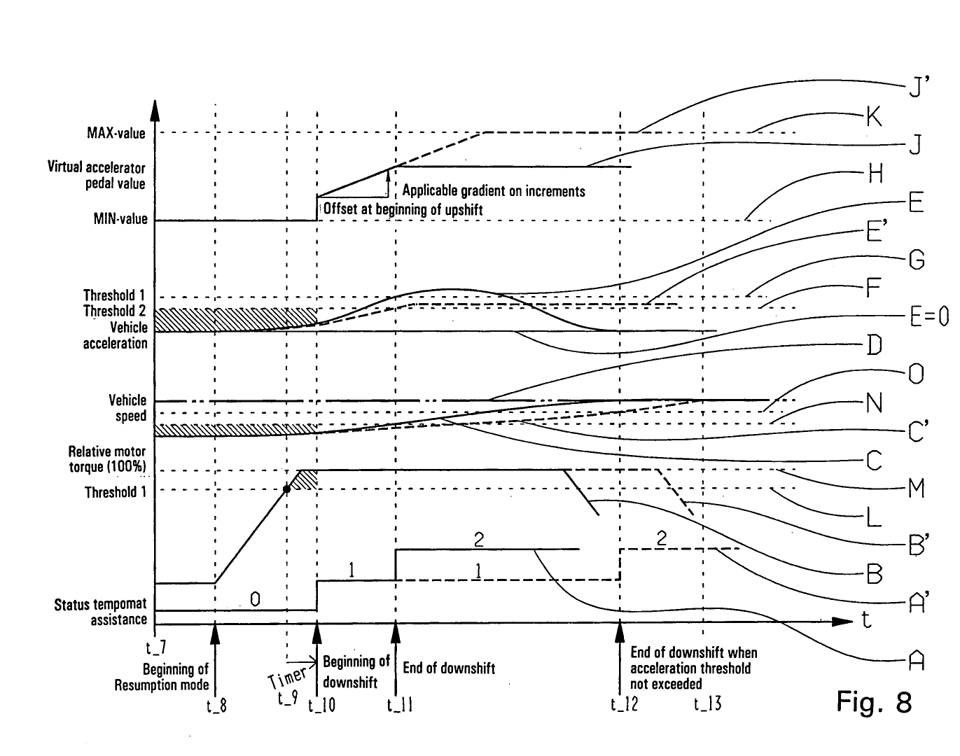

FIG. 8 is a diagram as in FIG. 7 but, during a driving speed resumption mode, with a transmission downshift by increasing the virtual accelerator pedal value;

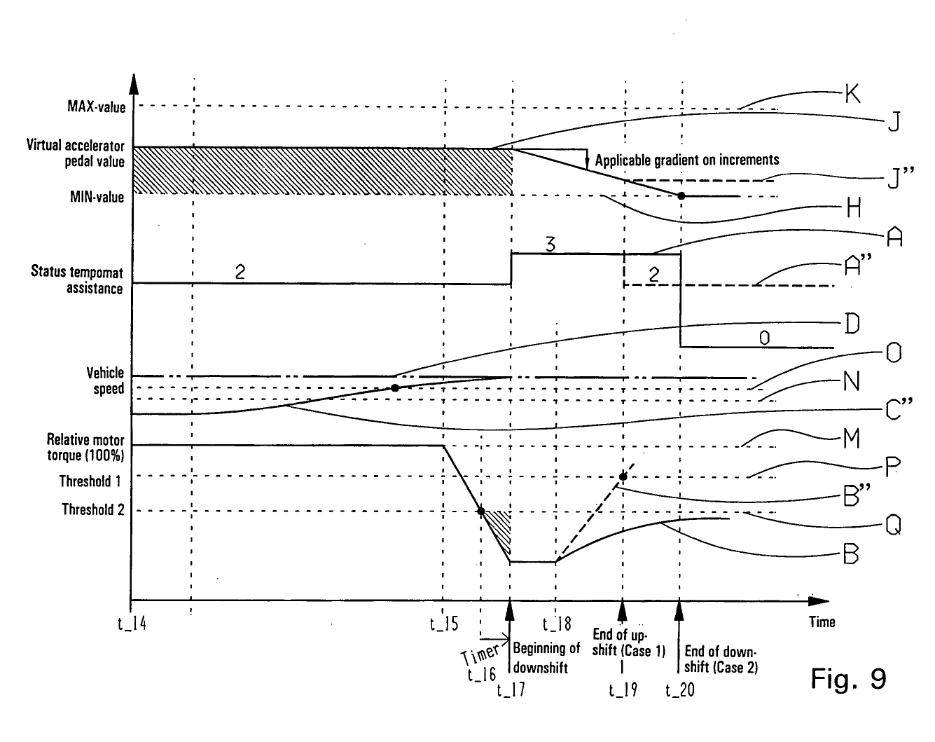

FIG. 9 is a diagram as in FIG. 8 but, with a transmission upshift, by breaking down the virtual accelerator pedal value; and

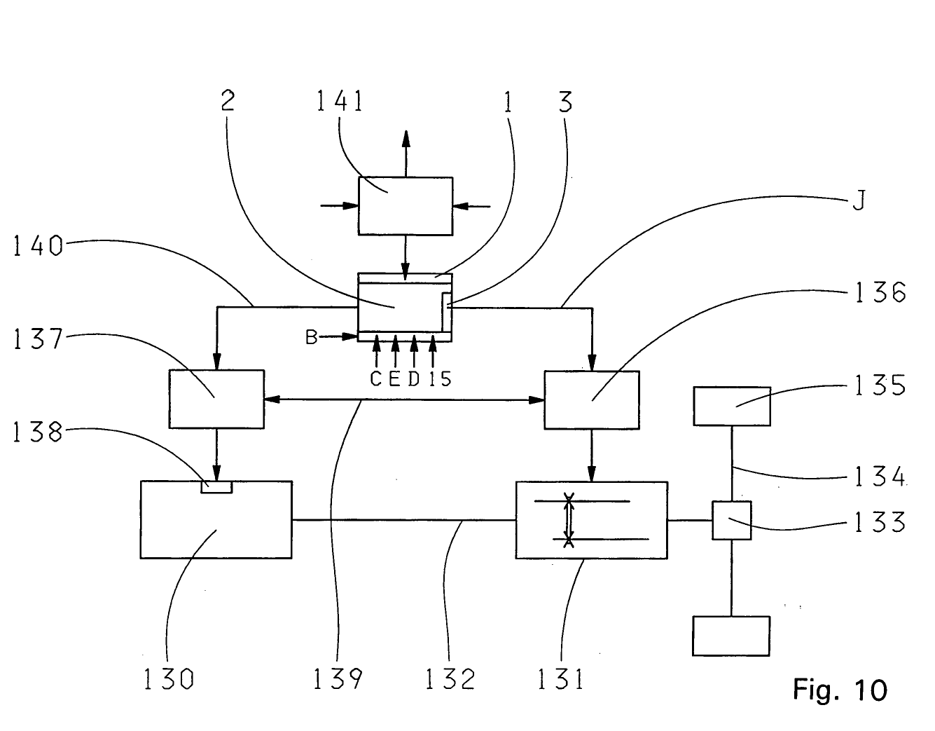

FIG. 10 is a schematized graph of a motor vehicle drive train with a device for applying the inventive method.

FIG. 10 accordingly shows in very schematized graph the structure of a vehicle drive train and simplifies the structure of a device for applying the inventive method. To the drive train belongs and internal combustion engine 130 connected via a crankshaft 132 with an automatic transmission 131 designed as CVT. The automatic transmission 131 drives in a manner known per se a differential transmission 133 from which branch out two axle drive shafts 134 leading to vehicle wheels 135.

While with the internal combustion engine 130 a motor control unit 137 is coordinated, the automatic transmission 131 is controlled by a control device 136. Both control units are connected via one line 139 for interchanging information.

Furthermore, with this vehicle drive train is coordinated one speed control device and/or one distance control device 141 symbolized by the two arrows and which receives for its control activities necessary information from sensors and/or adjusting devices, the same as, if needed, from other control units. To the extent, that a distance control device is used, the driving speed control function thereof is of special interest in relation to the instant invention. As one of its output parameters this device 141 communicates to one computer 2, here separately designed, information concerning its actual driving speed state. This parameter is taken up by the computer 2 in an inlet area 1 and further processed as described below.

As other input parameters, the computer 2 takes up values like the motor torque B, the vehicle speed C, the vehicle acceleration D and the accelerator pedal deviation angle designated herebelow as real accelerator pedal value 15.

In addition, the computer 2, via a control line 140, can act upon the motor control device 137 which for its part acts for adjusting the motor torque to the performance adjusting element 138 of the internal combustion engine 130.

Finally, the computer 2 has internal calculation modules with which, from the information taken up, in the manner to be described above, the virtual accelerator pedal value J is formed and relayed via an outlet area 3 to the transmission control unit 136 for change of ratio of the automatic transmission 131. The virtual accelerator pedal value, briefly said, is determined according to the motor torque B, the vehicle speed C, the vehicle acceleration D, the accelerator pedal value 15 and the actual speed control functions of the speed control and/or distance control device 141.

It is not indispensable that the computer 2 be designed as separate unit. It can be also component part of the transmission control unit 136, of the motor control unit 137, or of the speed an/or distance control device 141 without for this reason the structure and mode of operation of said coordinated functions having to be substantially different.

The inner construction and mode of operation of the computer 2, the same as the interaction thereof with other control units or aggregates of the vehicle, will be described above.

FIG. 1 shows the general program structure for applying an inventive method and an appertaining sectioning of an computer regarding the operating areas thereof essential to the invention. The function blocks are first simplified and then explained in detail.

To the extent that individual components of the drawing are designated as blocks, function blocks, processing blocks, calculation blocks, modules, comparators or other, with them are meant program steps, program modules or subprograms of a superposed control and regulation program. This at least one control and regulation program can be operated in a computer 2, in a transmission control unit 136, a speed and/or distance control unit 141 or in a motor control unit 137. To that extent, said blocks, function blocks, processing blocks, calculation blocks, modules, comparators and others, can also be implemented as device component parts such as fixedly coordinated computer structures.

Function block 1 symbolizes the inlet area of the computer 2 or a signal in relation to the start up of the speed control function of the speed control or distance control device 141, which in the Figures of this embodiment of the invention, is also designated as “Tempomat.” The starting status thereof is accordingly relayed as an input parameter to the computer 2 which controlled thereby calculates a virtual accelerator pedal value which can be used for determining and adjusting the transmission reduction ratio optimal of the driving situation.

In a processing block 6, the motor torque, relative motor torque, vehicle longitudinal acceleration and the driving speed difference between a preset nominal driving speed and the actual driving speed are detected or calculated.

An acceleration pedal value J calculated is shown as an initial parameter in FIG. 1 by a function block 3 and is relayed to another calculation module or to the transmission control unit 136. It also can be seen in FIG. 1 that the calculated virtual accelerator pedal value J can be fed as an input parameter by a feedback to a calculation block 5 (arrow 8), as it will be later discussed.

Prior to calculation of the virtual accelerator pedal value in a calculation block 7, an initialization (block 4) of the calculation process is first undertaken in the computer 2. In block 5 is then determined the actual status of the driving speed control assistance for adaptation of the transmission reduction ratio in a manner suitable to the driving situation. For the purpose, the vehicle longitudinal acceleration or vehicle longitudinal retardation information (block 5) is used relative to the actual motor torque, the same as, if needed, to an eventual difference of the driving speed from a nominal driving speed preset to the driving speed control manually or automatically, for example, by a vehicle distance control.

The status of the driving speed assistance is here expressed by a parameter “A” which can assume an integral value from zero to three (block 5). The value zero stands here for “no shifting activity”, the value one for “at the moment ongoing downshift” (increase virtual accelerator pedal value), the value two for “keep active the transmission ratio at the moment” (keep virtual accelerator pedal value) and the value three for “upshift ongoing at the moment” (reduce virtual accelerator pedal value); see also block 112.

The program structure for initializing the calculation process, according to block 4, is shown in detail in FIG. 2. As shown in this Figure, it is first inquired in a step 10 whether the driving speed control is for the first active in this phase of use of the vehicle. If the result is negative, there is already, according to block 11, the calculated virtual accelerator pedal value J utilizable for determining the transmission reduction ratio.

As long as the driving speed control is active for the first time in this operation phase, it is branched to a calculation block 12 in which the starting value for the status A of assistance of the driving speed control by the transmission and for the virtual accelerator pedal value are determined. For the purpose, in a calculation block 13, the actual measured real accelerator pedal value 15 (for example, accelerator pedal deviation angle) is comparted with an established minimum value 16 for the virtual accelerator pedal value in a maximum value generator 17. If the real accelerator pedal value 15 is higher than the minimum value, the latter is issued from the maximum value generator 17.

A temporary virtual accelerator pedal value 18 thus obtained is then checked in a calculation block 14 in a comparison step 19 in the sense of whether the virtual accelerator pedal value 18 just determined is higher than the minimum value 16 for the virtual accelerator pedal value. If this is so, then it is decided that the status value A for the driving speed control assistance be set at the value two and the actual virtual accelerator pedal value be maintained (processing block 20).

Insofar as the virtual accelerator pedal value 18 is not higher than the minimum value 16, no further activity is carried out and the status value A for the driving speed control assistance is set at zero (processing block 21).

In a calculation block 25, FIG. 3 shows a calculation cycle for determining the status value A for the driving speed control assistance, especially regarding the conditions for a transmission downshift in a resumption and constant speed mode of the driving speed control. In these operating modes of the driving speed control, this nominal driving speed is returned to and controlled as constant driving speed after an outdrive relative to the nominal driving speed precisely in force for the driving speed control.

It is accordingly checked in a processing block 30 with an inquiry 31 whether the driving speed control is in an acceleration mode and in an inquiry 32 determined whether the speed difference between the actual driving speed and the preset nominal driving speed is higher than a preset threshold value. If at least one of the two inquiries in a condition module 33 turns out positive, in another inquiry module 37, it is determined whether the vehicle longitudinal acceleration is below an acceleration threshold value (threshold 2) (comparison module 34), whether the relative motor torque is greater than a relative motor torque threshold value (threshold 1) (block 35) and whether at the time just no transmission downshift occurs (A unlike one). If all said conditions for introducing a downshift are met, a timer is started (command 38). If this is not so, then the timer is set at the value zero (command 39).

In the processing block 40 it is checked in an inquiry block 41 whether the timer has been set so high that a preset maximum time (“threshold”) has been exceeded or the preset time interval has expired. If this is so (comparator 43) and, at the moment, no activity of the driving speed assistance is to be registered according to a processing step 42 (A=zero), the virtual accelerator pedal value is raised by one offset value (process step 44) and thus a downshift of the transmission is started. The offset value is here preferably greater than an incremental change value for determining the actual virtual accelerator pedal value. This produces a better dynamic, especially at the start of the downshift.

In a processing block 50 is shown that, according to the process step 51, after expiration of the timer with regard to the same time interval from block 40, according to process step 52, the status of the driving speed control assistance is set at the value A=one and the timer is set at the zero value.

FIG. 4 shows a processing block 60 which indicates the conditions under which a transmission downshift is terminated. Accordingly, in a process step 61, it is checked whether a downshift has precisely been actively carried out. Besides, in a comparison inquiry 62 is determined whether the vehicle longitudinal acceleration is greater than a preset threshold value (threshold 1) and, in a comparison inquiry 63 is determined whether a speed difference between the actual driving speed and the preset nominal driving speed is less than a preset threshold value (threshold). Finally, in a method step 64 is checked whether the driving speed control is not in the acceleration mode (step 64).

If the reply to method steps 63 and 64 in a comparator 65 is positive or it has been established in an inquiry 66 that the inquiry 62 was replied in the affirmative, it is additionally examined in an inquiry 67 whether the question 61, with regard to the downshift, had a positive reply also. When said conditions have been met, the downshift of the transmission is terminated and, according to process step 68, the status of the driving speed control assistance is set at the value A=two whereby the virtual accelerator pedal value applicable a the time is maintained.

FIG. 5 shows the determination of the status A of the driving speed control assistance for upshifts. In a processing block 110 can be seen, at the same time, the conditions or method steps for introducing an upshift operation and in a processing block 111 those for terminating such an upshift.

Accordingly, in a block 70 it is checked in process steps 71 to 73 whether the actual virtual accelerator pedal value is higher than or equal to the already mentioned minimum value for the virtual accelerator pedal value; whether the relative motor torque is smaller than a relative motor torque threshold (threshold 2) and whether the speed difference between the actual driving speed and the preset nominal driving speed is lower than a preset threshold value (threshold). If the examination of said three conditions in a working step 74 shows that they have been met for introducing an upshift, the timer is started according to a process step 75. If that is not the case then, according to a process step 76, the timer is set at the zero value.

As a processing block 80 shows, following the process step 75, it is checked in a process step 81 whether a preset time interval has lapsed in the timer. If this is so, according to a process step 82, the status of the driving speed control assistance is set at the value A=three, which identifies an upshift precisely going on, that is, a breakdown of the virtual accelerator pedal value and the timer is set at the zero value.

To terminate a precise ongoing upshift, it is inquired in the processing block 90 in process steps 91 to 93 whether the relative motor torque is above a relative motor torque threshold (threshold 1); whether the virtual accelerator pedal value is higher than a preset minimum accelerator pedal value and whether the status of the driving speed control assistance is at the value A=three, that is, an upshift has just been carried out. Insofar as according to a comparison inquiry 95 said three conditions apply, according to a process step 95, the status of the driving speed control assistance is set at the value A=two. This means that if during an upshift operation the motor torque becomes too great, the upshift is terminated and in the state that follows the virtual accelerator pedal value is first kept constant.

Alternative to this, according to a processing block 100, an upshift terminates when the virtual accelerator pedal value is reduced to a value lower than or equal to the preset minimum of the virtual accelerator pedal value. It is, therefore, examined in a step 101 whether the virtual accelerator pedal value is lower than or equal to said minimum of the virtual accelerator pedal value and whether the status of the driving speed control assistance is set at the value A=three (ongoing upshift) (comparison inquiry 102). If both questions are answered in the affirmative, the status of the driving speed control assistance is set at A=zero in a process step 104 which means that no other activity occurs relative to the transmission.

In a further processing block 112, FIG. 6 further shows, in detail, the calculation of the virtual accelerator pedal value. Accordingly, in a memory 113 of the driving speed control assistance are stored the status values zero, one, two and three, as the already mentioned change criteria of the virtual accelerator pedal value. Individual status values 114, depending on the sensitized and as already shown calculated driving operation state of the vehicle, are assigned to a status value memory 115, as needed, which forms a control parameter for a program switch 122.

The program switch 122 can assume three shifting positions in which it connects its input side alternatively to each other with one of three adding elements 119, 120 and 121. To said adding elements 119, 120 and 121 is fed, so to say, regenerated from the last calculation loop, the actual virtual accelerator pedal value J and from increment memories are loaded with increments 116 for an increase or increments 117 for a reduction of said actual virtual accelerator pedal value or are left unchanged (an increment memory 118 with increment=zero).

Since the program switch 122, depending on the precise actual assistance situation with introduced driving speed control, can shift between the three shift positions one=“ongoing downshift”, three=“ongoing upshift” and zero or two=“no activity” or “maintain shift”; the virtual accelerator pedal value is adapted in small incremental steps based on the existing situation so that transmission shifting operations are carried out in an optimal driving dynamic way without pendular shifting inclination.

As FIG. 6 makes clear, it is further provided for the purpose that the output parameter of the program switch 122, that is, of the changed or unchanged virtual accelerator pedal value, with the aid of a maximum comparator 124 and a minimum comparator 126, is again checked in the sense of whether it is lower or higher than a minimum value 123 or a maximum value 125 preset at the time so that said limiting values for the virtual accelerator pedal value are in no manner fallen below or exceeded. The virtual accelerator pedal value J thus formed then also to a regenerated virtual accelerator pedal value (feedback arrow 8) according to FIG. 1 so that, on the one hand, it can be used for the actual transmission ratio control and, on the other, be available for recalculation of the actual virtual accelerator pedal value taking place in the next program loop cycle.

As these explanations make clear, according to the invention an actual virtual accelerator pedal value is calculated by gradual buildup, breakdown or maintenance of the former virtual accelerator pedal value from the last program cycle. But characteristics or comparison and calculation operations of the actual program course also depend on the previously determined state or status of the assistance of the driving speed control by transmission shifting operations.

FIG. 7 to FIG. 9, respectively, show downshift and upshift operations on vehicles having a speed control and a continuously variable automatic transmission which were carried out with the aid of the inventive method and an inventively designed device. According to the characteristics of a continuously variable automatic transmission, increasing vehicle longitudinal acceleration values are also to be tabulated here during the ratio change operations (hereinafter designated as “shifting” for the sake of simplicity). This is known to be attributed to the fact that during ration change operations of those automatic transmissions, no interruption occurs of the traction of the vehicle. The inventive method and the inventive device obviously can also be used in multi-step transmissions, but here the observation and evaluation of the vehicle longitudinal acceleration during the ratio change operation are of reduced importance.

Accordingly, in a schematized diagram, FIG. 7 does different vehicle characteristics relevant to driving and shifting, plotted in the course of time during a drive controlled by a driving speed control with desired constant nominal driving speed in which a downshift operation of the transmission takes place for assisting the speed control function.

The curve A identifies here the status value of the driving speed control assistance; a curve B, the course of the relative motor torque; a curve C, the driving speed; a curve D, the nominal driving speed preset to the speed control; a curve E, the vehicle longitudinal acceleration; a straight line F and threshold value “threshold 2”, and a straight line G, a threshold value “threshold 1” for the vehicle longitudinal acceleration; a straight line H, a minimum value for the virtual accelerator pedal value; a curve J, a cycle of the virtual accelerator pedal value 127; a straight line K, a maximum value for the virtual accelerator pedal value; a straight line L, a threshold value for the relative motor torque; a straight line M, the 100% mark of the relative motor torque, and a straight line E=O, the zero line of the vehicle longitudinal acceleration.

As can be seen from FIG. 7, the time section here observed of the driving operation of an inventively controlled and regulated vehicle begins with a moment t₀ in which the driving speed C, controlled by a driving speed control, corresponds to a previously adjusted nominal driving speed. From said moment to the moment t₁ inclusive, the motor torque B, the driving speed C and the vehicle longitudinal acceleration E run constant.

By increasing the tractional resistance caused, for example, by an increased road gradient, the driving speed C becomes reduced from the moment t₁ so that by the driving speed control 141 action is exerted directly or via the computer 2 and/or the motor control device 137 upon a performance adjusting element 138 of a vehicle prime mover 130 in the sense of raising the motor torque B. Thereby the positive and thus also the relative motor torque B increase until the motor torque B has reached the maximum value at this motor rotational speed and with regard to its other time curve coincides with the 100% mark M of the relative motor torque until again reaching the nominal driving speed.

Starting from the moment t₃ the driving speed falls below a lower threshold value N in relation to the nominal driving speed D. By this occurrence is started a timer which allows a preset time interval t₃-t₄ to lapse. Within said time interval t₃-t₄, if the driving speed C does not rise again above the speed threshold N, at the moment t₄, a transmission downshift is introduced which is identified particularly by the change of status of the speed control assistance A from a value zero to the value one.

As FIG. 7 makes clear, by said change of status, the virtual accelerator pedal value J is also changed. The latter thus increases at the moment t₄ from the minimum value H directly at the beginning of the downshift by addition of an offset value in order to be adapted in the other time curve by the inventively provided incremental change based on the driving situation. Determined by the increase of the virtual accelerator pedal value J in the time interval t₄-t₅, a downshift takes place and thus also increases the vehicle longitudinal acceleration E the same as the driving speed C.

At the end of the downshift operation at the moment t₅, the vehicle motor still runs at full load (B=M) while the vehicle longitudinal acceleration E, after exceeding a first threshold value F, has also exceeded an upper threshold value G. The driving speed C increases agin at this moment.

It can also be seen in FIG. 7 that at the moment t₅, the status value A for assistance of the speed control unit is set at a value two. The consequence of this change of the status value is that the program switch 122, shown in FIG. 6, leaves the now valid virtual accelerator pedal value unchanged for the time being.

The assistance of the speed control mechanism by a time-oriented transmission ratio change in the sense of a downshift leads in the other time curve starting from the moment t₆ to a best possible adaptation of driving speed C and nominal driving speed D so that now the motor torque B controlled by influence of the accelerator pedal control is reduced again to below the 100% mark (threshold value M) of the relative motor torque.

FIG. 8 shows how the function of the speed control is assisted in the above mentioned resumption function by a downshift of the transmission. Said resumption function is identified by the fact that, departing from a positive driving speed C below a preset nominal driving speed D, said nominal driving speed D is automatically reached again.

According to the inventive method, for deciding whether the virtual accelerator pedal value J must be increased, there are evaluated, together with the speed difference between the positive driving speed C and the nominal driving speed D, also the reaching of a preset relative motor torque threshold L, the same as in addition the vehicle longitudinal acceleration E. It is thereby obtained that the nominal driving speed D, under adequate environmental conditions, be exclusively reached by the existing motor torque B and, if needed, a transmission downshift can be prevented.

From the diagram shown in FIG. 8 it can be understood that at the moment t₇ the existing driving speed C is below two threshold values and O and far below the nominal driving speed D. Moreover, the virtual accelerator pedal value J assumes a preset minimum value H while the motor torque B is comparatively low, the same as below a threshold value L and below the 100% mark (threshold value M) of the relative motor torque. A vehicle longitudinal acceleration E does not occur, wherefore its value amounts to zero. The status value A for the program switch 122 is, at this moment t₇, set to zero according to the curve A which means that no transmission shifting activity is to be carried out or goes on.

At the moment t₈ said resumption mode is activated in the speed control by a corresponding control command triggered, for example, by the vehicle driver or by an autonomously working distance control system. In consequence hereof, the speed control acts according to signalizing technique upon the performance adjusting element of the prime mover so that the latter is led to emitting a higher motor torque B. At the moment t₉, as soon as the motor torque B has reached the threshold value L, a timer is started. In FIG. 8, it can also be detected that after exceeding said threshold value L, the vehicle longitudinal acceleration E can be measured from the value zero to positive values. Slight increase can also be determined in driving speed C.

After expiration of a preset time interval t₉-t₁₀, when the motor torque B still is above the threshold value L, the value of the vehicle speed is below the threshold value N and the vehicle longitudinal acceleration is below the threshold value F, the status value A for the program switch 122 is set at one. Thereby the virtual accelerator pedal value J affecting the transmission shifting operation is first gradually raised by an offset value above the former minimum value H and during the ongoing downshift raised by addition of incremental low values to always higher values. In this phase, the prime mover of the vehicle emits its maximum torque B.

At the moment t₁₁, as soon as the vehicle longitudinal acceleration E has reached a preset upper threshold value G, this is considered as a signal for terminating the downshift operation. Therefore, at the moment t₁₁, the status value A for the program switch 122 is set at the value two. This results in that the program switch 122 does not further increase the precisely valid virtual accelerator pedal value J.

By virtue of the reduction ratio now adjusted, the vehicle longitudinal acceleration E rises further in the time interval t₁₁-t₁₂ in order then, before reaching the moment t₁₂, to drop to the value zero. Just then, when the acceleration has reached the value zero, the motor torque B is again reduced to below the torque threshold value L by acting upon the performance adjusting element of the vehicle prime mover. The driving speed C then reached at the moment t₁₂ the nominal driving speed D, as desired.

In a variant of the downshift operation just described, during a driving speed resumption function, the acceleration operation develops comparatively slower, as can be understood with reference to the curves shown in bold dots. Accordingly, a vehicle longitudinal acceleration C′ does not reach the upper acceleration threshold G after beginning of the transmission downshift at the moment t₁₀. Therefore, the status value A for the program switch 122 is kept for a comparatively long time at a value one (curve A′) so that a virtual accelerator pedal value J′ is increased until there has been reached the maximum value K for the virtual accelerator pedal value J′ stored in the maximum value memory 135.

In this case, the end of the downshift operation is established by the driving speed C′ reaching at the moment t₁₂ a predetermined threshold value O below the nominal driving speed D. If this has occurred, then the status value A for the program switch 122 is set at the value two. The nominal driving speed D is reached at the moment t₁₃ from the actual driving speed C′ during this resumption function of the driving speed.

FIG. 9 finally shows the already described characteristic parameters of the vehicle in a driving speed resumption function of the speed control which is assisted by a change of the transmission reduction ratio. Departing from a driving speed C below the nominal driving speed D, the prime mover of the vehicle is here operated so that it emits its maximum torque B (B=M). The status value A for the program switch 122 is in this sate set at the value two which means that the precisely existing virtual accelerator pedal value is to be maintained.

By the full load operation of the prime mover the driving speed C rises continuously in the interval t₁₄-t₁₅. Shortly after said driving speed C has reached its upper threshold value O, the motor torque B lowers due to the action upon the performance adjusting element of the vehicle prime mover. As soon as the latter has reached at the moment t₁₆ a value below the threshold value Q, a timer is started.

Insofar as after expiration of predetermined time interval t₁₆-t₁₇, the motor torque B is still below the threshold value Q and the vehicle speed above the threshold value O, the status value A for the program switch 122 is set at the value three which means that a transmission upshift is carried out by lowering the virtual accelerator pedal value. At the same time the motor torque B is regulated from a moment t₁₇ to constant keeping of the vehicle speed.

At the beginning of the upshift at the moment t₁₇, the driving speed C has reached the nominal driving speed D while by changing said status value A, the virtual accelerator pedal value J is reduced by small steps. As soon as the virtual accelerator pedal value J has at the moment t₂₀ reached the minimal value H established in the minimum memory 124 for the virtual accelerator pedal value J, the status value A for the program switch 122 is set at the value zero which means that there will be no further activity relative to the transmission whereby the upshift is terminated.

One variant of this is shown by the curves in bold dots. Accordingly, at the moment t₁₈ the motor torque B″ is more sharply increased than in the embodiment shown in the first variant according to FIG. 9 whereby the upshift is already terminated at the moment t₁₉. For the purpose the status value A″ for the program switch 122 is set at the value two. Consequently, the virtual accelerator pedal value J″ is kept at the value then valid already prior to reaching its minimum value H.

### REFERENCE NUMERALS

1 inlet area, speed control states
2 computer
3 outlet area for relaying the virtual accelerator pedal value
4 initialization block
5 calculation block for status determination
6 calculation block motor torque, acceleration
7 calculation block of virtual accelerator pedal value
8 feedback of the virtual accelerator pedal value
10 enquiry step, enquiry module
11 assignment block utilization of last accelerator pedal value
12 calculation block of the initialization
13 calculation block of initializing the virtual accelerator pedal value
14 calculation block assistance status
15 real accelerator pedal value
16 minimum value for the virtual accelerator pedal value
17 maximum value generator
18 actually calculated preliminary virtual accelerator pedal value
19 comparison step
20 processing block
21 processing block
25 calculation block for conditions for downshift in the mode of driving speed resumption or constant speed
30 processing block
31 enquiry
32 enquiry
33 condition module
34 comparison module
35 comparison module
36 comparison module
37 enquiry module
38 command to start timer
39 command to set at zero the timer
40 processing block
41 enquiry block
42 processing step
43 comparator
44 process step
50 processing block
51 process step enquiry of timer cycle
52 process step status change and timer at zero
60 processing block
61 process step
62 comparison enquiry
63 comparison enquiry
64 enquiry step
65 enquiry step
66 enquiry step
67 enquiry step
68 process step
70 processing block
71 process step
72 process step
73 process step
74 enquiry step
75 process step
76 process step
80 processing block
81 process step
82 process step
90 processing block
91 process step
92 process step
93 process step
94 comparison enquiry
95 process step
100 processing block process step
101 status value for just expiring high control
102 comparison enquiry
103 process step
104 processing block
110 processing block for determining the conditions for beginning an upshift
111 processing block for determining the conditions for end of an upshift
112 processing block for determining the virtual accelerator pedal value
113 status value memory
114 status value
115 status value memory
116 increment, increment memory
117 increment, increment memory
118 increment, increment memory
119 summation element
120 summation element
121 summation element
122 program switch
123 minimum value for the virtual accelerator pedal value
124 comparison step, maximum comparator
125 maximum value for the virtual accelerator pedal value
126 comparison step, minimum comparator
130 internal combustion engine
131 automatic transmission
132 crankshaft
133 differential transmission
134 drive shaft
135 vehicle wheel
136 transmission control unit
137 motor control unit
138 performance adjusting element of the internal combustion engine
139 line
140 line
141 speed and/or distance control
t time
t₀-t₂₀ moments
A status value driving speed or distance control assistance by change of transmission ratio
A′ status value driving speed or distance control assistance by change of transmission ratio
A″ status value driving speed or distance control assistance by change of transmission ratio
B relative motor torque, motor torque
B′ relative motor torque, motor torque
B″ relative motor torque, motor torque
C driving speed
C′ driving speed
D nominal driving speed
E vehicle acceleration
E′ vehicle acceleration
F lower positive threshold value vehicle longitudinal acceleration
G upper positive threshold value vehicle longitudinal acceleration
H minimum value for the virtual accelerator pedal value
J virtual accelerator pedal value
J′ virtual accelerator pedal value
J″ virtual accelerator pedal value
K maximum value for the virtual accelerator pedal value
L upper threshold value for the motor torque
M maximum value of the relative motor torque
N lower threshold value for the motor torque
O upper threshold value of the vehicle speed

1-26. (canceled)

27. A method for operating a motor vehicle having an automatic transmission with one or more of a speed and distance control device, the method comprising the steps of:
departing from an actual driving speed (C), a preset nominal driving speed (D) is autonomously regulated;
adaptation of the actual driving speed (C) to a nominal driving speed (D) is influenced by a ratio change of the automatic transmission;
ratio change control is effected on the basis of a virtual accelerator pedal value (J, J′, J″) which is derived from a real deviation of the accelerator pedal (15) by a driver, definition of the virtual accelerator pedal value (J, J′, J″) being controlled by deviation of the driving speed (C) from the nominal driving speed (D), by one or more of a vehicle longitudinal acceleration (E) and by a torque (B) of the vehicle prime mover.

28. The method according to claim 27, further comprising the step of the virtual accelerator pedal value (J, J′, J″) is changed in incremental small steps.

29. The method according to claim 27, further comprising the step of the virtual accelerator pedal value (J, J′, J″) for introducing a change of ratio is changed by an offset value the amount of which is higher than that of an incremental change thereof.

30. The method according to claim 27, further comprising the step of determining a virtual accelerator pedal value (J, J′, J″) by taking into account one or more of reaching and exceeding of at least one preset motor torque threshold value (L, M, P, Q).

31. The method according to claim 27, further comprising the step of determining a virtual accelerator pedal value (J, J′, J″), one or more of reaching and exceeding of at least one preset threshold value (L, M, P, Q) of a relative motor torque is taken into account, the relative motor torque being defined as a ratio of the actual motor torque to a maximum possible motor torque at a specific rotational speed of the motor.

32. The method according to claim 27, further comprising the step of determining a virtual accelerator pedal value (J, J′, J″), one or more of reaching and exceeding of at least one preset threshold value (N, O) for the driving speed (C) is taken into account.

33. The method according to claim 27, characterized in that to determine the virtual accelerator pedal value (J, J′, J″) the reaching and/or exceeding of at least one preset threshold value for a vehicle longitudinal acceleration (F, G) is taken into account.

34. The method according to claim 27, characterized in that during a constant speed control operation, when the tractional resistance of the vehicle is increased for reestablishing the present nominal driving speed (D), the motor torque (B) is first increased, that when the motor torque (B) emitted by the prime mover is not sufficient to maintain or reach the nominal driving speed (D) again, starting from a predetermined speed divergence from the nominal driving speed (D), the virtual accelerator pedal value (J, J′, J″) is gradually increased and that said gradual increase of the accelerator pedal value (J, J′, J″) for control of the change of ratio is terminated when the motor performance suffices to reach at least a predetermined vehicle longitudinal acceleration (E).

35. The method according to claim 27, characterized in that in a driving-speed resumption control for again reaching a preset nominal driving speed (D), starting from the actually lower driving speed (C) to a decision of whether the virtual accelerator pedal value (J, J′, J″) must be raised, there is evaluated, together with the speed difference between the actual driving speed (C) and the nominal driving speed (D), the exceeding of a motor torque threshold (L. M, P, Q) or of a threshold value of the relative motor torque, the same as the non-reaching of the threshold value (F) relative to a vehicle longitudinal acceleration.

36. The method according to claim 35, further comprising the step of, when the motor torque (B) suffices to raise the driving speed (C) with a vehicle longitudinal acceleration above the threshold value (F) to the value of the nominal driving speed (D), a change of ratio of the transmission is omitted.

37. The method according to claim 27, further comprising the step of a virtual accelerator pedal value (J, J′, J″) is gradually reduced for carrying out a transmission upshift when the motor torque (B) falls below a preset torque threshold value (Q) and the virtual accelerator pedal value (J, J′, J″) is higher than a minimum value (H) for the virtual accelerator pedal value (J, J′, J″).

38. The method according to claim 27, further comprising the step to carry out a constant speed driving mode with reference to a preset nominal driving speed (D), one or more of the speed and distance control device and the automatic transmission are operated as follows:
establish a reduction of the driving speed (C) from the present nominal driving speed (D) by a preset driving speed differential amount,
increase the motor torque (B) by control of the performance adjusting element of the vehicle prime mover,
insofar as in a preset motor rotational speed the prime mover emits a maximum torque (M), the driving speed (C) drops below a preset threshold value (N) and the vehicle longitudinal acceleration (E), compared to an initial situation has an insufficient acceleration value, release a timer,
when after expiration of a preset time interval (t₃-t₄), the prime mover still emits the maximum torque (B at the threshold value M) at the existing rotation speed and the driving speed (C) is below the driving speed threshold value (N), the same as the vehicle longitudinal acceleration (E) is below a longitudinal acceleration value (F), add the offset value to the actual virtual accelerator pedal value (J) and thereby begin a transmission downshift,
incremental increase of the virtual accelerator pedal value (J) for further downshift until the vehicle longitudinal acceleration (E) has reached a preset positive acceleration threshold value (G),
terminate the incremental increase of the virtual accelerator pedal value (J) and thus end the downshift,
reduce the motor torque (B) when the driving speed (C) has reached the nominal driving speed (D).

39. The method according to claim 27, characterized in that to reach again a preset nominal driving speed (D), one or more of the speed and distance control device is operated as follows:
at a driving speed (C) below a preset speed threshold value (N), raise the motor torque (B) to a torque threshold value (L),
when upon reaching said torque threshold value (L), the driving speed (C) is still below the speed threshold value (N) and the vehicle longitudinal acceleration (E) is below the threshold value (F), release a timer,
when after expiration of a preset time interval (t₉-t₁₀), the prime mover emits a maximum torque (B) at the threshold value (M) at the existing rotational speed and the driving speed (C) is below the speed threshold value (N) and the vehicle longitudinal acceleration (E) is below the threshold value (F), add an offset value to the virtual accelerator pedal value (J) and thus begin a transmission downshift,
incremental increase of the virtual accelerator pedal value (J) for further downshift until the vehicle longitudinal acceleration (D) has reached a preset positive threshold value (G),
terminate the incremental increase of the virtual accelerator pedal value (J) and thus end the downshift,
reduce the motor torque (B) when the driving speed (C) has reached the nominal driving speed (D),

40. The method according to claim 27, characterized in that to reach again a preset nominal driving speed (D), one or more of the speed and distance device and the automatic transmission are operated as follows:
at a driving speed (C) which is below a preset speed threshold value (N), raise the motor torque (B) up to a torque threshold value (L),
when upon reaching said torque threshold value (L), the driving speed (C) is still below the speed threshold value (N) and the vehicle longitudinal acceleration (E) is below the threshold value (F), release a timer,
when after expiration of a preset time interval (t₉-t₁₀), the prime mover emits a maximum torque (B) at threshold (M) at the existing rotational speed and the driving speed (C) is below the speed threshold value (N) and the vehicle longitudinal acceleration (E) is below the threshold value (F), add an offset value to the virtual accelerator pedal value (J) and being a transmission downshift,
incremental increase of the virtual accelerator pedal value (J′) and the transmission downshift going therewith until said value has reached a predetermined maximum accelerator pedal value (K),
terminate the downshift when the vehicle longitudinal acceleration (E) has not exceeded a threshold value (G) but the driving speed (C) has reached a driving speed threshold value (O) close to the nominal driving speed (D) or has reached the nominal driving speed (D) proper,
reduce a motor torque (B′).

41. The method according to claim 27, further comprising the step to reach the preset nominal driving speed (D) again or carry out a drive with constant driving speed (D), one or more of the speed and distance control device and the automatic transmission are operated as follows:
insofar as the prime mover emits a maximum torque (B) at threshold (M) at the precisely existing motor rotational speed, the driving speed (C) is above the upper speed threshold value (O) and the virtual accelerator pedal value (J) is between the minimum value (H) and the maximum value (K), lower the motor torque (B),
insofar as the motor torque (B) has reached a lower threshold value (Q) and the above mentioned conditions still hold, start a timer,
when a predetermined time interval (t₁₆-t₁₇) has expired and the above mentioned conditions still hold, begin a transmission upshift by incremental reduction of the virtual accelerator pedal value (J),
regulate the motor torque from a moment (t₁₇) to constantly keeping the vehicle speed (C),
terminate the upshift operation by ending the reduction of the virtual accelerator pedal value (J) when this has reached a predetermined minimum value (H),
terminate the upshift operation by ending the reduction of the virtual accelerator pedal value (J″) when a motor torque (B″) has reached a predetermined upper torque threshold value (P) which is between the lower torque threshold value (Q) and the maximum motor torque (M) that can be emitted at the existing rotation speed.

42. A device for assisting a speed control function in a motor vehicle having one or more of a speed control and distance control device (141), one prime mover (130), one motor control unit (137), one automatic transmission (131), one transmission control unit (136) and one computer (2), said computer (2) according to signal technology is connected with the motor control unit (137), the transmission control unit (137) and the one or more of speed and distance control device (141) and integrated in one of said units, the computer (2) having:
one input module (1) for receiving information relative to the actual control status of the one or more of speed and distance control device (141),
one initialization module (4) to determine a virtual accelerator pedal value (J) from the actual accelerator pedal actuation (15),
one determination module (6) to determine a motor torque (B), vehicle acceleration (E) and a difference between an actual driving speed (C) and a preset nominal driving speed (D),
one determination module (5) to determine an actual status (A) of assistance of the speed control function by changing a transmission reduction ratio,
one calculation module (7, 112) to calculate an actual accelerator pedal value (J, J′, J″) and
one input module (3) to issue the actual accelerator pedal value (J, J′, J″) to the transmission control unit (136) for control of the reduction ratio.

43. The device according to claim 42, wherein the initialization module (4) has:
one inquiry module (10) in which is determined whether the one or more of the speed control device and the space control device is active for the first time since one of the last initial operation of the vehicle or the last driving speed control assistance,
one assignment module (11) which in case of a negative result of the inquiry in the inquiry module (10) assigns the actual virtual accelerator pedal value for subsequent processing; and
one calculation block (12) to be used in case of positive result of the inquiry and in which is determined actual starting values for the virtual accelerator pedal value (A) of assistance of the speed control or distance control device with regard to the transmission ratio operations.

44. The device according to claim 43, wherein a calculation block (12) contains the one calculation block (13) where the actual real accelerator pedal value (15) can be checked in a maximum value generator (17) as to whether said real accelerator pedal value (15) can be checked in a maximum value generator (17) as to whether said real accelerator pedal value (15) is higher than a minimum value (16) for the virtual accelerator pedal value, there being issued as output parameter of said maximum value generator (17) the value higher at the moment than an actually calculated virtual accelerator pedal value (18).

45. The device according to claim 43, wherein a calculation block (12) comprises one other calculation block (14), the input parameter of which is the virtual accelerator pedal value (18), that in this other calculation block (14), in a comparison step (19), can be inquired whether the actual virtual accelerator pedal value (18) is higher than a minimum value (16) for the virtual accelerator pedal value and that the output of said comparison step (19) is connected regarding a positive reply with one other processing block (20) and regarding a negative reply with one additional processing block (21), with the other processing block (20) the status value (A) can be set in a status value memory (115) at the value two and with the additional processing block (21), the status value (A) can be set in the status value memory (115) at the value zero.

46. The device according to claim 42, wherein a calculation module (7, 112) has for calculating the virtual accelerator pedal value (J, J′, J″), a first increment generator (116) for an increase and a second increment generator (117) for a reduction of the virtual accelerator pedal value, the same as one zero value increment generator (118).

47. The device according to claim 46, wherein a calculation module (7, 112) for calculating the virtual accelerator pedal value (J, J′, J″) has one status memory (113) for storing status indices (zero, one, two, three) which mark whether one of no activity is to take place regrading a transmission change of ratio, whether a reduction of the accelerator pedal value takes place at the time, whether an increase of the virtual accelerator pedal value takes place at the time and whether a virtual accelerator pedal value existing at the time is to be kept.

48. The device according to claim 46, wherein a calculation module (7, 112) has a program switch (122) which is connected via summation elements (119, 120, 121) with increment generators (116, 117, 118).

49. The device according to claim 48, wherein to summation elements (119, 120, 121) can be fed via a feedback (8) the virtual accelerator pedal value (J, J′, J″) of the last calculation loop.

50. The device according to claim 42, wherein with the program switch (122) can be relayed for subsequent processing that the incrementally changed accelerator pedal value (J, J′, J″) which had been changed according to the precisely valid assistance status (113) and stored in the status memory (115).

51. The device according to claim 42, wherein a calculation module (7, 112) has one minimum value memory (123) for a determinable lower limiting value and one maximum value memory (125) for determinable upper limiting value of the virtual accelerator pedal value, an outlet of the program switch (122) is connected with the inlet of a first comparator (124) which is also connected with a minimum value memory (123), an outlet of the first comparator (124) is connected with an inlet of a second comparator (126) which is also connected with the maximum value memory (125) and that the outlet of the second comparator (126) forms the actual virtual accelerator pedal value (J, J′, J″) which corresponds to one of the minimum value, the maximum value or is therebetween.

52. The device according to claim 42, wherein the motor vehicle has a transmission which is designed as a continuous reduction-ratio changing automatic transmission (131).
